(19) United States
(12) Patent Application Publication
(10) Pub. No.: US 2009/0092869 A1
(43) Pub. Date: Apr. 9, 2009

(54) Apparatus for generating hydrogen and fuel cell power generation system having the same

(75) Inventors: Kyoung-Soo Chae, Suwon-si (KR); Jae-Hyuk Jang, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/078,795

(22) Filed: Apr. 4, 2008

(30) Foreign Application Priority Data
Oct. 4, 2007 (KR) 10-2007-0100013

(51) Int. Cl. H01M 8/06; C25B 1/02

(52) U.S. Cl. 429/21; 204/228.4; 429/25

(57) ABSTRACT

An apparatus for generating hydrogen by dissociating an electrolyte solution includes: an electrolyte bath, in which an outlet is formed, and which contains the electrolyte solution; an anode coupled to the electrolyte bath that generates electrons; a cathode coupled to the electrolyte bath that receives the electrons from the anode to generate hydrogen; a filter, which covers the outlet to filter out foreign substances carried in the hydrogen; a pressure sensor coupled inside the electrolyte bath that senses the pressure inside the electrolyte bath and generates an output signal corresponding to the pressure; and a control unit, electrically connected with the anode and the cathode, which controls the flow of electricity between the anode and the cathode in response to the output signal. Using the apparatus, safety hazards caused by increases in the pressure inside the electrolyte bath can be prevented.

### CROSS-REFERENCE TO RELATED APPLICATIONS

This application claims the benefit of Korean Patent Application No. 10-2007-0100013 filed with the Korean Intellectual Property Office on Oct. 4, 2007, the disclosure of which is incorporated herein by reference in its entirety.

### BACKGROUND

1. Technical Field

The present invention relates to an apparatus for generating hydrogen and a fuel cell power generation system having the same.

2. Description of the Related Art

A fuel cell is an apparatus that converts the chemical energies of fuel (hydrogen, LNG, LPG, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes. As such, the fuel cell is a relatively new technology for generating power, which offers high efficiency and few environmental problems.

Examples of fuel cells being researched for application to portable electronic devices include the polymer electrolyte membrane fuel cell (PEMFC), which uses hydrogen as fuel, and the direct liquid fuel cell, such as the direct methanol fuel cell (DMFC), which uses liquid fuel directly. The PEMFC provides a high output density, but requires a separate apparatus for supplying hydrogen. Using a hydrogen storage tank, etc., for supplying the hydrogen can result in a large volume and can require special care in handling and keeping.

Methods used in generating hydrogen for a polymer electrolyte membrane fuel cell (PEMFC) can be divided mainly into methods utilizing the oxidation of aluminum, methods utilizing the hydrolysis of metal borohydrides, and methods utilizing reactions on metal electrodes. Among these, one method of efficiently regulating the rate of hydrogen generation is the method of using metal electrodes. This is a method in which the electrons obtained when magnesium in the electrode 220 is ionized to Mg²⁺ ions are moved through a wire and connected to another metal object, where hydrogen is generated by the dissociation of water. The amount of hydrogen generated can be regulated, as it is related to the distance between electrodes and the sizes of the electrodes.

In generating hydrogen, however, errors in regulating the flow rate of hydrogen within the reactor can lead to excessive internal pressures and in some cases to a risk of safety hazards. Thus, there is a need for an apparatus for generating hydrogen and a fuel cell power generation system equipped with a safety device for preventing such safety hazards when generating hydrogen.

### SUMMARY

An aspect of the invention is to provide an apparatus for generating hydrogen and a fuel cell power generation system, with which safety hazards, such as those due to excessive pressure within the electrolyte bath, can be prevented.

One aspect of the invention provides an apparatus for generating hydrogen by dissociating an electrolyte solution. The apparatus includes: an electrolyte bath, in which an outlet is formed, and which contains the electrolyte solution; an anode, which is coupled to the electrolyte bath, and which is configured to generate electrons; a cathode, which is coupled to the electrolyte bath, and which is configured to receive the electrons from the anode to generate hydrogen; a filter, which can cover the outlet to filter out foreign substances carried in the hydrogen; a pressure sensor, which is coupled inside the electrolyte bath, and which senses the pressure inside the electrolyte bath and generates an output signal corresponding to the pressure; and a control unit, electrically connected with the anode and the cathode, which is configured to control the flow of electricity between the anode and the cathode in response to the output signal.

In certain embodiments, the apparatus for generating hydrogen may further include a sealing material, which may cover the pressure sensor to prevent the electrolyte solution from penetrating in.

The sealing material can be made of a flexible material.

If the pressure inside the electrolyte bath exceeds a particular value, the pressure sensor may generate a break signal as the output signal and transfer the break signal to the control unit, at which the control unit may break the flow of electricity between the anode and the cathode in response to the break signal.

If the pressure inside the electrolyte bath falls below a particular value, the pressure sensor may generate an operate signal as the output signal and transfer the operate signal to the control unit, at which the control unit may enable the flow of electricity between the anode and the cathode in response to the operate signal.

Another aspect of the invention provides a fuel cell power generation system for producing electrical energy using hydrogen generated by dissociating an electrolyte solution. The fuel cell power generation system includes: an electrolyte bath, in which an outlet is formed, and which contains the electrolyte solution; an anode, which is coupled to the electrolyte bath, and which is configured to generate electrons; a cathode, which is coupled to the electrolyte bath, and which is configured to receive the electrons from the anode to generate hydrogen; a filter, which can cover the outlet to filter out foreign substances carried in the hydrogen; a pressure sensor, which is coupled inside the electrolyte bath, and which senses the pressure inside the electrolyte bath and generates an output signal corresponding to the pressure; a control unit, electrically connected with the anode and the cathode, which is configured to control the flow of electricity between the anode and the cathode in response to the output signal; and a fuel cell configured to convert chemical energy of the hydrogen generated at the cathode to produce the electrical energy.

A sealing material may further be included, which can cover the pressure sensor to prevent the electrolyte solution from penetrating in.

The sealing material can be made of a flexible material.

If the pressure inside the electrolyte bath exceeds a particular value, the pressure sensor may generate a break signal as the output signal and transfer the break signal to the control unit, at which the control unit may break the flow of electricity between the anode and the cathode in response to the break signal.

If the pressure inside the electrolyte bath falls below a particular value, the pressure sensor may generate an operate signal as the output signal and transfer the operate signal to the control unit, at which the control unit may enable the flow of electricity between the anode and the cathode in response to the operate signal.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic diagram illustrating an embodiment of an apparatus for generating hydrogen according to one aspect of the invention.

FIG. 2 is a schematic diagram illustrating an embodiment of a fuel cell power generation system according to another aspect of the invention.

### DETAILED DESCRIPTION

Embodiments of the apparatus for generating hydrogen and a fuel cell power generation system having the apparatus according to certain aspects of the invention will be described below in more detail with reference to the accompanying drawings, in which those components are rendered the same reference numeral that are the same or are in correspondence, regardless of the figure number, and redundant explanations are omitted.

It is to be noted that the coupling of components encompasses not only the direct physical engaging between the components, but also the engaging of the components with another element interposed in-between such that the components are in contact with the other element.

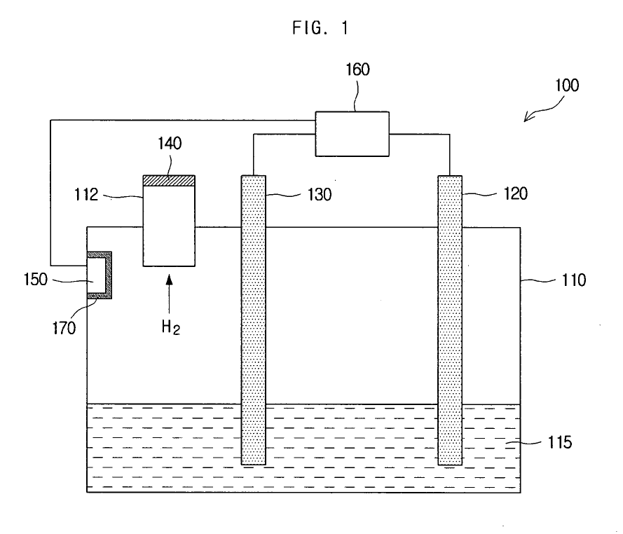

FIG. 1 is a schematic diagram illustrating an embodiment of an apparatus for generating hydrogen according to one aspect of the invention. In FIG. 1 are illustrated a hydrogen generating apparatus 100, an electrolyte bath 110, an outlet 112, an electrolyte solution 115, an anode 120, a cathode 130, a filter 140, a pressure sensor 150, a control unit 160, and a sealing material 170.

In this particular embodiment, an apparatus for generating hydrogen 100 is presented, in which a pressure sensor 150 is installed inside the electrolyte bath 110, to prevent the pressure inside the electrolyte bath 110 from increasing beyond a threshold pressure due to the foreign substances filtered onto the filter 140 coupled to the outlet 112 of the electrolyte bath 110. As a result, safety hazards, such as the electrolyte bath 110 bursting, can be prevented.

The electrolyte bath 110 may contain an electrolyte solution 115 that produces hydrogen by way of dissociation. An outlet 112 may be formed on one side of the electrolyte bath 110, which in turn may be covered by the filter 140.

An anode 120 and a cathode 130 may be coupled inside the electrolyte bath 110, so that a reaction for generating hydrogen may be performed from the electrolyte solution 115 contained in the electrolyte bath.

A compound such as LiCl, KCl, NaCl, KNO₃, NaNO₃, CaCl₂, MgCl₂, K₂SO₄, Na₂SO₄, MgSO₄, AgCl, etc., can be used in the electrolyte solution 115, and the electrolyte solution 115 may contain hydrogen ions.

The anode 120 may be an active electrode, and may be coupled inside the electrolyte bath 110 to generate electrons. The anode 120 can be made, for example, of magnesium (Mg), and due to the difference in ionization tendency between the anode 120 and hydrogen, the anode 120 may release electrons into the water and may be oxidized into magnesium ions (Mg²⁺).

The electrons generated may travel to a control unit 160 electrically connected with the anode 120, and to the cathode 130 electrically connected with the control unit 160. As such, the anode 120 may be expended in accordance with the electrons generated, may be configured to allow replacement after a certain period of time. Also, the anode 120 may be made of a metal having a greater tendency to ionize than the material used for the cathode 130 described below.

The cathode 130 may be an inactive electrode and may not be expended, unlike the anode 120, and thus the cathode 130 may be implemented with a lower thickness than that of the anode 120. The cathode 130 may be coupled inside the electrolyte bath 110, and may receive the electrons generated at the anode 120 to generate hydrogen. The cathode 130 can be made, for example, of stainless steel, and may react with the electrons to generate hydrogen. That is, the chemical reaction at the cathode 130 involves water being dissociated to form hydrogen at the cathode 130 after receiving the electrons from the anode 120.

The reaction above can be represented by the following Reaction Scheme 1.

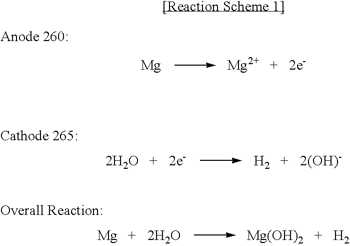

The control unit 160 may be electrically connected with the anode 120 and cathode 130 to control the flow of electricity between the anode 120 and cathode 130. The operation of the control unit 160 in response to output signals of the pressure sensor 150 according to this embodiment will be described in detail layer.

The control unit 160 may be inputted with the amount of hydrogen required by the fuel cell, and if the required value is high, may increase the amount of electrons flowing from the anode 120 to the cathode 130, or if the required value is low, may decrease the amount of electrons flowing from the anode 120 to the cathode 130.

For example, the control unit 160 may include a variable resistance, to regulate the electric current flowing between the anode 120 and cathode 130 by varying the resistance value, or may include an on/off switch, to regulate the electric current flowing between the anode 120 and cathode 130 by controlling the on/off timing.

The filter 140 may cover the outlet 112 to filter out foreign substances carried in the hydrogen. The hydrogen generated at the cathode 130 may be outputted through the outlet 112 while carrying foreign substances such as particles from the slurry, which can become a cause of degraded performance in a fuel cell power generation system using the hydrogen generating apparatus 100.

Thus, by coupling the filter 140 to the electrolyte bath 110 such that the filter 140 covers the outlet 112, foreign substances such as the slurry can be prevented from being outputted, and as a result, pure hydrogen can be generated efficiently.

In cases where the hydrogen generating apparatus 100 is used for long periods of time, however, the filter 140 can become blocked by the foreign substances filtered by the filter 140, which may cause the pressure inside the electrolyte bath 110 to increase, and may eventually create a risk of safety hazards, such as of having the electrolyte bath 110 burst, etc.

As such, by coupling the pressure sensor 150 to an inside of the electrolyte bath 110, the bursting, etc., of the electrolyte bath 110 can be avoided.

The pressure sensor 150 may be coupled inside the electrolyte bath 110, and may generate an output signal that corresponds with the pressure, where the generate signal may be transferred to the control unit 160. Moreover, the pressure sensor 150 may be enveloped by a sealing material 170, to prevent the penetration of the electrolyte solution 115. This will be described later in more detail.

The pressure sensor 150 may, if the pressure inside the electrolyte bath 110 is increased to or beyond a particular value, i.e. exceeds a threshold pressure, generate a break signal for the output signal, and may transfer this break signal to the control unit 160. Furthermore, the control unit 160 may receive the break signal, and break the flow of electricity, i.e. the electrical connection, between the anode 120 and the cathode 130 in response to the break signal.

Here, the threshold pressure can mean the internal pressure of the electrolyte bath 110 that enables the electrolyte bath 110 to operate without subjecting the hydrogen generating apparatus 100 to bursting. The threshold pressure may vary according to the physical properties of the material used in forming the electrolyte bath 110.

Also, if the pressure inside the electrolyte bath 110 is decreased to or below a particular value, i.e. falls below a threshold pressure, generate an operate signal for the output signal, and may transfer this operate signal to the control unit 160. Furthermore, the control unit 160 may receive the operate signal, and enable the flow of electricity in response to the break signal, such that the anode 120 and the cathode 130 are electrically connected.

In other words, the pressure sensor 150 may sense the pressure inside the electrolyte bath 110, and if the pressure inside the electrolyte bath 110 exceeds a threshold pressure, may generate a break signal as the output signal and send it to the control unit 160, and if the pressure inside the electrolyte bath 110 falls below the threshold pressure again, may generate an operate signal as the output signal and send it to the control unit 160, while the control unit 160 may break or enable the flow of electricity between the anode 120 and the cathode 130 according to the output signal, to regulate the amount of hydrogen generated such that the electrolyte bath 110 may be prevented from bursting.

By thus coupling a pressure sensor 150 to the inside of the electrolyte bath 110, even when a filter 140 is coupled to the outlet 112 of the electrolyte bath 110 and foreign substances are filtered onto the filter 140 so that the internal pressure of the electrolyte bath 110 is increased, the pressure sensor 150 can sense the internal pressure and generate an output signal that controls the flow of electricity in the anode 120 and cathode 130, to implement a safer hydrogen generating apparatus 100.

A sealing material 170 may cover the pressure sensor 150 to prevent the electrolyte solution 115 from penetrating in. As the pressure sensor 150 is coupled inside the electrolyte bath 110 and is subject to exposure to the electrolyte solution 115, in order that the pressure sensor 150 may operate without malfunctioning, the sealing material 170 may envelop the pressure sensor 150 and protect the pressure sensor 150 from the electrolyte solution 115.

In this case, the sealing material 170 can be made of a flexible material, so as to reduce possible errors that may occur in the pressure sensor 150 in sensing pressure, so that the amount of hydrogen generated can be regulated more effectively.

According to this embodiment, by using a pressure sensor 150 to sense the pressure inside the electrolyte bath 110, in a hydrogen generating apparatus 100 that includes a filter 140 for removing foreign substances, the pure hydrogen as required by a fuel cell can be supplied in a more stable and efficient manner, without the risk of the electrolyte bath 110 bursting.

Next, an embodiment will be described of a fuel cell power generation system according to another aspect of the present invention.

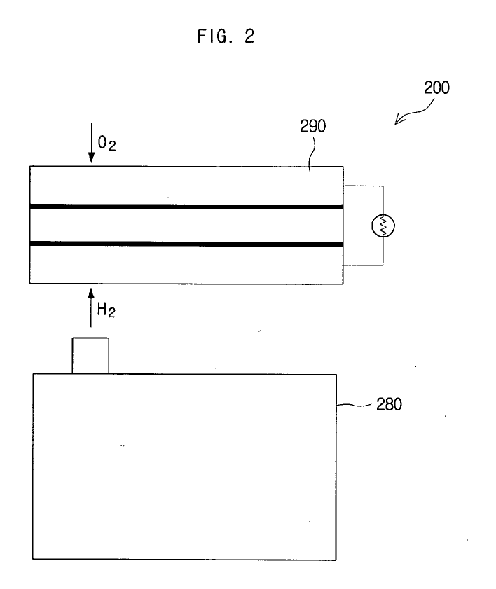

FIG. 2 is a schematic diagram illustrating an embodiment of a fuel cell power generation system according to another aspect of the invention. In FIG. 2, there are illustrated a fuel cell power generation system 200, a hydrogen generating apparatus 280, and a fuel cell 290.

In this particular embodiment, a fuel cell power generation system 200 is presented, in which a pressure sensor is installed inside the electrolyte bath, to prevent the pressure inside the electrolyte bath from increasing beyond a threshold pressure due to the foreign substances filtered onto the filter coupled to the outlet of the electrolyte bath. As a result, safety hazards, such as the electrolyte bath bursting, can be prevented, and electrical energy can be produced in a stable manner.

In this embodiment, the composition of the hydrogen generating apparatus 280 is substantially the same as or is in correspondence with that of the embodiment described above of an apparatus for generating hydrogen 100 (FIG. 1) according to an aspect of the invention, and thus will not be described again. The descriptions that follow will focus on the fuel cell 290, which forms the differences from the previously described embodiment.

The fuel cell 290 can convert the chemical energy of hydrogen generated at the cathode to produce electrical energy. That is, the pure hydrogen generated at the hydrogen generating apparatus 280, which may be equipped with a filter that removes foreign substances without creating a risk of safety hazards due to increases in internal pressure, can be moved to the fuel electrode of the fuel cell 290, where the chemical energy of the hydrogen generated at the hydrogen generating apparatus 280 described above may be converted into electrical energy to produce a direct current.

According to this embodiment, by using a pressure sensor to sense the pressure inside the electrolyte bath, the hydrogen generated in a hydrogen generating apparatus, which includes a filter for removing foreign substances without a risk of the electrolyte bath bursting, can be supplied to the fuel cell 290 to produce electrical energy, whereby a fuel cell power generation system 200 can be implemented that is more efficient and more stable.

As set forth above, the use of certain embodiments of the invention can prevent safety hazards caused by increases in the pressure inside the electrolyte bath.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An apparatus for generating hydrogen by dissociating an electrolyte solution, the apparatus comprising:
an electrolyte bath having an outlet formed therein and containing the electrolyte solution;
an anode coupled to the electrolyte bath and configured to generate electrons;
a cathode coupled to the electrolyte bath and configured to receive the electrons from the anode to generate hydrogen;
a filter configured to cover the outlet and filter out foreign substances carried in the hydrogen;
a pressure sensor coupled inside the electrolyte bath and configured to sense a pressure inside the electrolyte bath and generate an output signal corresponding to the pressure; and
a control unit electrically connected with the anode and the cathode and configured to control a flow of electricity between the anode and the cathode in response to the output signal.

2. The apparatus for generating hydrogen of claim 1, further comprising:
a sealing material covering the pressure sensor to prevent the electrolyte solution from penetrating in.

3. The apparatus for generating hydrogen of claim 2, wherein the sealing material is made of a flexible material.

4. The apparatus for generating hydrogen of claim 1, wherein, if the pressure inside the electrolyte bath exceeds a particular value, the pressure sensor generates a break signal as the output signal and transfers the break signal to the control unit, and
the control unit breaks the flow of electricity between the anode and the cathode in response to the break signal.

5. The apparatus for generating hydrogen of claim 4, wherein, if the pressure inside the electrolyte bath falls below a particular value, the pressure sensor generates an operate signal as the output signal and transfers the operate signal to the control unit, and
the control unit enables the flow of electricity between the anode and the cathode in response to the operate signal.

6. A fuel cell power generation system for producing electrical energy using hydrogen generated by dissociating an electrolyte solution, the fuel cell power generation system comprising:
an electrolyte bath having an outlet formed therein and containing the electrolyte solution;
an anode coupled to the electrolyte bath and configured to generate electrons;
a cathode coupled to the electrolyte bath and configured to receive the electrons from the anode to generate hydrogen;
a filter configured to cover the outlet and filter out foreign substances carried in the hydrogen;
a pressure sensor coupled inside the electrolyte bath and configured to sense a pressure inside the electrolyte bath and generate an output signal corresponding to the pressure;
a control unit electrically connected with the anode and the cathode and configured to control a flow of electricity between the anode and the cathode in response to the output signal; and
a fuel cell configured to convert chemical energy of the hydrogen generated at the cathode to produce the electrical energy.

7. The fuel cell power generation system of claim 6, further comprising:
a sealing material covering the pressure sensor to prevent the electrolyte solution from penetrating in.

8. The fuel cell power generation system of claim 7, wherein the sealing material is made of a flexible material.

9. The fuel cell power generation system of claim 6, wherein, if the pressure inside the electrolyte bath exceeds a particular value, the pressure sensor generates a break signal as the output signal and transfers the break signal to the control unit, and
the control unit breaks the flow of electricity between the anode and the cathode in response to the break signal.

10. The fuel cell power generation system of claim 9, wherein, if the pressure inside the electrolyte bath falls below a particular value, the pressure sensor generates an operate signal as the output signal and transfers the operate signal to the control unit, and
the control unit enables the flow of electricity between the anode and the cathode in response to the operate signal.
